(19) United States
(12) Patent Application Publication
(10) Pub. No.: US 2021/0097463 A1
(43) Pub. Date: Apr. 1, 2021

(54) Decentralized Resource Management System

(71) Applicant: Solutech, Inc., New Haven, CT (US)

(72) Inventors: Nathan Pitruzzello, New Haven, CT (US); Arielle Telesmanic, Branford, CT (US)

(21) Appl. No.: 16/585,209

(22) Filed: Sep. 27, 2019

(51) Int. Cl. G06Q 10/06; H04L 9/06; G06Q 10/08

(52) U.S. Cl. CPC G06Q 10/06313; G06Q 10/087; H04L 9/0637

(57) ABSTRACT

A decentralized resource planning system is provided having a computer, a ledger in data communication with said computer, software executing on said computer for receiving rules and recording said rules on the ledger, software executing on said computer for receiving a user authorization and an update, and retrieving rules from the ledger based on the user authorization or the update, software executing on said computer for transmitting the update based on the rules and receiving a response, and software executing on said computer for recording at least one of the update and the response on the ledger.

### TECHNICAL FIELD

The present invention generally relates to a decentralized resource management system, and specifically to a decentralized enterprise resource planning system.

### BACKGROUND

In conventional supply chain management software, each company maintains their own systems and databases. Every company involved in a transaction must therefore expend resources inputting data into their own system. As a result, these supply chain management systems are inefficient, and require large investments to maintain. Data must be input into the system every time a transaction is updated, which is time consuming and can lead to errors. Even if the system is maintained perfectly, another company may dispute the status of a transaction because a discrepancy exists between their respective systems. This lack of a universally accepted truth to the data can form the basis of a dispute between companies. In addition, data from multiple disparate systems may not be usable, communicable, or trustworthy. Therefore, a system is required that provides for reliable and trustworthy supply chain data management that is fast and efficient to update and maintain.

Furthermore, conventional systems provide no quick and easy way to selectively share information or maintain control after sharing information. Resources (such as warehouse space) are likely wasted because there is no way to efficiently communicate capacity between companies. Accordingly, a system that allows for near-real time communication of supply chain information between companies is required.

Moreover, conventional systems do not effectively promote internal asset management or internal optimization of communication. Accordingly, a system that allows a company to leverage assets and increase communication is required.

### SUMMARY

An object of the invention is to optimize the efficiency of supply chain data that is stored, processed, transmitted, structured, and analyzed.

It is an object of the present invention to quicken the end-to-end flow of information in a supply chain by disseminating information with more efficiency and granularity.

It is a further object of the invention increase the usability of data from multiple disparate systems by providing a solution that communicates how to use data effectively and whether to trust such data.

It is a further object of the invention to make data more usable to help internal and external collaboration by removing rigid data usage and allowing for change and communication on how data is used.

It is a further object of the invention to ensure that no company or user owns data, but the usage of grouped data can be trusted.

It is a further object of the invention to automate the storage of records on an immutable ledger.

It is a further object of the invention to reduce costs associated with the collection of data and to reinforce already calculable data.

It is a further object of the invention to leverage and make accessible updates and approval data input to the system.

It is a further object of the invention to analyze real time data to govern decision loops in a supply chain.

It is an object of the present invention to provide a system where dedicated nodes perform a sequence of transaction processing protocols.

It is a further object of the invention to use a system of ledgers produced with different owners, with multiple parties writing information to the system of ledgers.

It is a further object of the invention to use a public ledger in connection with private ledgers to enhance data integrity and trust.

It is an object of the invention to encrypt any data written to ledgers for security and user access control.

It is a further object of the invention to use rules as an automatic trigger to pull and store redundant data on a private or public blockchain. Such rules can automate data that is shared to specific stakeholders based on milestones or decision points that are tracked by a conventional system and communicated to a smart contract.

The present invention allows for the tracking of business transactions with increased data integrity and trust. In addition, the present invention allows additional benefits. For example, the invention allows companies to share excess resource information to sell access to those resources. The inventive system can be used to publicize that a distribution facility has excess capacity available to hold product. Manufacturers would be able to use this information to minimize lead time, especially if the facility is close to other components in their supply chain.

As an additional example, the present invention allows for automating and increasing sales of inventory and or contracted production of more or customized items. By linking quotes made by consumers to supply chain heath metrics, the system allows supply chain owners to calculate the price to build product and have customers' orders translate into supply chain management decisions. For example, a new order can be made for custom screws from a hardware e-commerce site. Instead of generating a quote, the inventive system can be used to calculate a price based on supply chain data for the customer to agree to. The system would then confirm the purchase and supply chain management data would be altered to ensure that the resources needed are allocated for this task and are not available for future buy orders until work is complete. In the inventive system, all agreements are immutable and recorded on both private and public ledgers enforcing trust between buyer and consumer. Later, this data could be leveraged to reconcile disputes. In addition, a trusted payment system could be provided to provide an all-in-one solution.

In one aspect of the invention, a decentralized resource planning system is provided having a computer, a ledger in data communication with said computer, software executing on said computer for receiving rules and recording said rules on the ledger, software executing on said computer for receiving a user authorization and an update, and retrieving rules from the ledger based on the user authorization or the update, software executing on said computer for transmitting the update based on the rules and receiving a response; and software executing on said computer for recording at least one of the update and the response on the ledger.

In another aspect of the invention, a decentralized resource planning system is provided having a computer, a private ledger in data communication with said computer, software executing on said computer for receiving rules and recording said rules on the private ledger, software executing on said computer for receiving a user authorization and an update, and retrieving rules from the ledger based on the user authorization or the update, software executing on said computer for transmitting the update based on the rules and receiving a response, software executing on said computer for recording the update on the private ledger, and software executing on said computer for transmitting at least one of the update and the response to a validator for recording the update on a public ledger.

In another aspect of the invention, a decentralized resource planning system is provided having a computer, a private ledger in data communication with said computer, software executing on said computer for receiving rules and recording said rules on the private ledger, software executing on said computer for transmitting the update based on the rules and receiving a response, software executing on said computer for generating a transaction based on at least one of the update and the response, software executing on said computer for recording the transaction on a private ledger, and software executing on said computer for transmitting a token and the transaction to a validator for recording the update on a public ledger.

Other embodiments of the system are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of the presently disclosed system.

FIG. 2 is a schematic diagram of the presently disclosed system.

FIG. 3 is a schematic diagram of the presently disclosed system.

### DETAILED DESCRIPTION

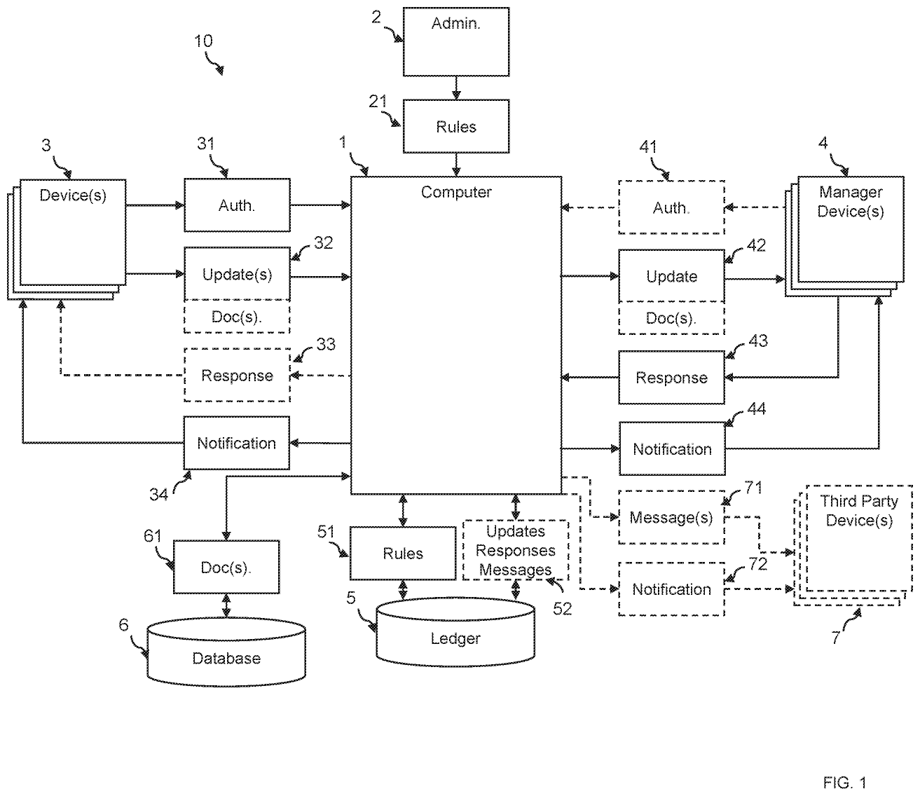

Referring to FIG. 1, the present disclosure describes a system 10 for decentralized resource planning.

The system 10 includes a computer 1. The computer 1 may be a processor, remote computer, computer server, network, or any other computing resource.

The computer 1 may be in data communication with an administrator 2. The administrator may be a computer, smartphone, tablet, or other electronic device capable of transmitting data to the computer 1. The administrator 2 may be a conventional database management system (“DBMS”).

The computer 1 may be in data communication with device(s) 3. Device(s) 3 may include a computer, laptop, smartphone, tablet, or other electronic device capable of transmitting data to the computer 1. The device 3 may be a DBMS.

The computer 1 may also be in data communication with manager devices 4. The manager devices 4 may include a computer, laptop, smartphone, tablet, or other electronic device capable of transmitting data to the computer 1. The manager devices 4 may have previously authenticated with the computer 1. The manager device 4 may be a DBMS.

The computer 1 may also be in data communication with a ledger 5. The ledger 5 may store information regarding the system 10, including rules, updates, responses, messages, etc. The ledger 5 may be a public, private, or hybrid blockchain. The ledger 5 may be immutable.

The computer 1 may also be in communication with a database 6. The database 6 may store information regarding the system 10, including electronic documents. The database 6 may be a storage drive or array accessible to computer 1. The database 6 may also include any cloud storage system, including those provided by Dropbox, Microsoft (OneDrive), Apple (iCloud), etc. The database 6 may be a DBMS.

The computer 1 may also be in communication with one or more third party device(s) 7. Third party device(s) 7 may include a computer, laptop, smartphone, tablet, or other electronic device capable of transmitting data to the computer.

The computer 1 may receive rules 21 from an administrator 2. The rules 21 may be requirements for data validation and acceptance. For instance, a rule 21 may require that other users validate an update. A rule 21 may also require certain users (for example, managers) to validate an update. The rule 21 may or may not be a sequence in which users must validate an update. Further, a rule 21 may require a certain percentage of users to may be required to approve of validate an update. In the case of multiple ledgers 5, a rule 21 may specify the ledger 5 to which it is to be applied. After the computer 1 receives a rule 21 from an administrator 2, it may be sent to manager devices 4 as an update 42, as discussed below.

The rules 21 may be modified by the computer 1 and stored on the ledger 5 as rules 51. Additional information may be used by the computer to generate rules 51, such as the administrator that set the rule 21, a timestamp of when it was set, and what types of data or projects to which the rule 21 applies.

The rules 21 may be executable smart contracts or defined conditions to be enforced to maintain and review access management. Rules 21 may also be simple smart contract functions to support manual new entries or automatic record copies (immutable shareable permissioned copy of transaction maintained in legacy system). Simple smart contract functions may include: push data, add user, delete user, and update access management (e.g., administrator(s) 2 who can propose or enact directly new rules 21).

The computer 1 may receive an authorization 31 from device 3. The computer 1 may also receive an authorization 41 from manager device(s) 4. The authorizations 31 and 41 may include any information necessary to verify an identity of device 3. For example, the authorizations 31 and 41 may be a username and password, a cryptographic key, or other manner of identification. Two-factor authorization, or any other manner of establishing a level of trust in the identity of the user of the device may be employed.

The computer 1 receives an update 32 from the device 3. For example, an update 32 could be a modified package delivery date, or a notice of a new purchase order. The update may be text-based. The update 32 may include one or more documents, such as Word documents, Excel spreadsheets, PowerPoint presentations or PDFs. The update may also include a request to access or save a document in database 6. In addition, the update may include a request to send a message 71 to at least one third party 7. The message 71 may include a document.

The computer 1 may record update 32 on the ledger 6. Additional information may be recorded with the update 32, such as the authorization 31, or a portion thereof (e.g., a username). In addition, a timestamp may be recorded. Further, if the update 32 modifies a previous update, the recording of the update 32 may reference the previous update. The computer may also transmit the update 32 to any device 3, manager device 4, or third-party device 7 in accordance with the rules 51 as a notification 34, 44, 72.

Furthermore, acceptance criteria for the update 32 may also be recorded. The computer 1 can query the ledger 5 to return rules 51 that apply to the update 32. The computer 1 can determine the acceptance criteria for the update 32 based on the rules 51, and record the acceptance criteria on the ledger with the update 32.

The computer 1 transmits the update 42 to the appropriate manager devices 4 based on the determined acceptance criteria. The transmitted update 42 can include any relevant documents, and other information such as the location of the recorded update on the ledger.

The computer 1 receives a response 43. The response 43 may indicate whether the update 42 is accepted. The computer may record the response 43 on the ledger 5 in a manner associating it with update 32. Additional information may be recorded with the response 43, such as the authorization 41, or a portion thereof (e.g., a username). In addition, a timestamp may be recorded. The computer may transmit the response 33 to the device 3 that provided update 32. The computer may also transmit the response 33 to any device 3, manager device 4, or third-party device 7 in accordance with the rules 51 as a notification 34, 44, 72.

If the acceptance criteria for the update is met, the computer can record that the update is accepted on the ledger 5. The computer may also send notifications 34, 44, 72 that the update has been accepted to any device 3, manager device 4, or third-party device 7 in accordance with the rules 51.

If the acceptance criteria for the update is met, the computer may provide access to database 6 to device 3 (or any other device), if the update 32 requested access. Further, the computer may send a message 71 (including any documents) to a third-party device 7 if the update 32 so requested. The messages 71 may be recorded on the ledger 5 in a manner associated with the update 32, and may include other information such as a timestamp.

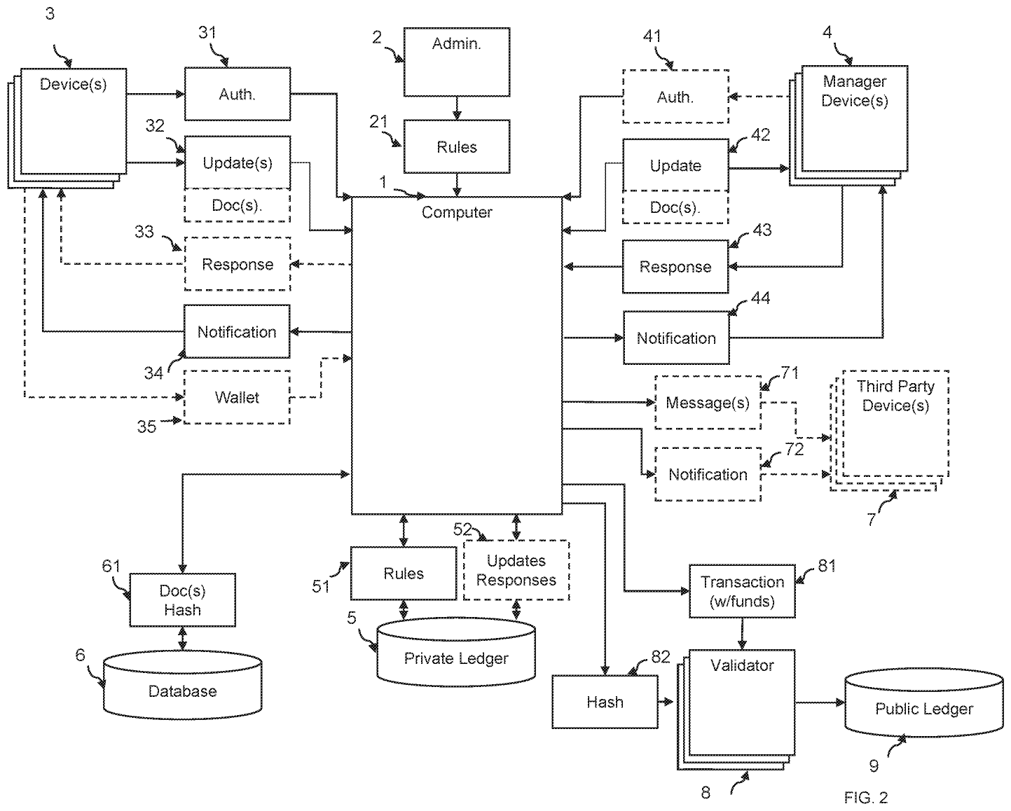

Additional aspects of the invention are shown in FIG. 2. In FIG. 2, private ledger 5 functions largely in the same manner as ledger 5 in FIG. 1. However, certain features, such as sending notifications 72 to third-party devices 7 regarding recordings on the ledger 5 will no longer be usable since the ledger 5 is private.

When the acceptance criteria is met for an update on the public ledger 9, the computer 1 converts the update 32 and associated responses 43 into a transaction 81 and sends it to a validator 8 for recording on a public ledger 9. Transaction 81 may be encrypted. The validator 8 may request funds from a wallet or an address associated therewith to record the update on the private ledger. The computer 1 receives the funds from a wallet (or address) associated with the device 3, and provides them to the validator 8. In this example, validator 8 is a combination of a validator and a miner. However, a person having ordinary skill in the art would understand that the validator and the miner can be separate.

Once the update is recorded on the public ledger 9, the computer 1 receives a hash 82 from the validator 8 associated with the recording. The computer 1 may record the hash 82 in the database 6. The computer 1 may also record the hash 82 in the private ledger 5 in a manner associating it with the transaction 81.

The computer 1 can send notifications 34, 44, 72 regarding the hash 82 to any device 3, manager device 4, or third-party device 7 in accordance with the rules 51.

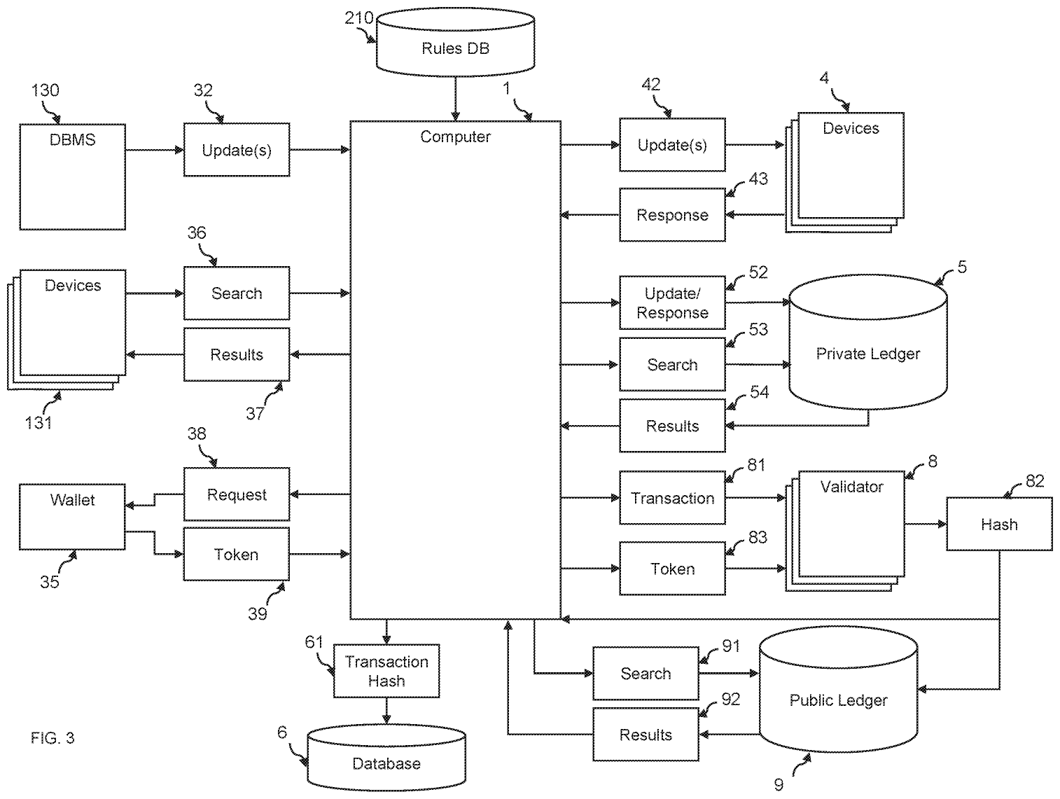

Additional aspects of the invention are shown in FIG. 3. In FIG. 3, rules 21 are stored in a rules database 210 accessible by computer 1. Computer constantly monitors legacy DBMS 130 for updates 32. In this case, updates 32 include authentication information regarding the user of the DBMS that generated the update.

Updates 32 are transmitted to devices 4 and recorded on the private ledger 8 in largely the same process as described above with reference to FIGS. 1 and 2. When the acceptance criteria for the update is reached, the update 32 and associated responses 43 are converted into a transaction 81, which may be encrypted. The computer may record the transaction 81 on the database 6. The computer 1 sends a request 38 for a calculated token amount to a wallet 35 (or an address associated with the wallet 35) associated with the DBMS. The computer receives a token(s) 39 from the wallet 35 (or address). The computer then sends the transaction 81 and a token(s) 83 to the validator 8. The validator 8 encrypts the transaction 81 and converts it into a hash 82, which is recorded on the public ledger 9. The computer receives the hash 82 from the validator and records it on the database 6. In this example, validator 8 is a combination of a validator and a miner. However, a person having ordinary skill in the art would understand that the validator and the miner can be separate.

The computer 1 may receive a search request 36 from devices 131 to search the public ledger 9 and/or private ledger 5. The computer can modify the search request to generate search request 53 and send it to private ledger 5. The computer can also modify the search request to generate search request 91 and send it to public ledger 9. Search results 54 and 92 may be received from the private ledger 5 and public ledger 9, respectively. Search results 54 and 92 may include recorded updates and responses 52 and hashes 82. Search results 54 and 92 may indicate if an update 52 met its acceptance criteria. Search results 37 are transmitted to the device 131. The search results 37 may be a combination or subset of results 54 and 92. For example, a user may not have permissions under the rules 210 to see all the results. As another example, the computer 1 may combine the results where duplicates exist on both the private ledger 5 and public ledger 9.

The computer 1 can also query the private ledger 5 and public ledger 9 to determine if any discrepancies exist. If discrepancies are found, the computer 1 may send a notification to the appropriate device(s) based on the rules 21.

In compliance with the patent statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A decentralized resource planning system, comprising:
a computer;
a ledger in data communication with said computer;
software executing on said computer for receiving rules and recording said rules on the ledger;
software executing on said computer for receiving a user authorization and an update, and retrieving rules from the ledger based on the user authorization or the update;
software executing on said computer for transmitting the update based on the rules and receiving a response; and
software executing on said computer for recording at least one of the update and the response on the ledger.

2. The system of claim 1, wherein the response includes a permission to access a database.

3. The system of claim 1, further comprising software executing on said computer for transmitting the response.

4. The system of claim 1, wherein the update includes a document or a message.

5. The system of claim 1, further comprising at least one database for storing transaction information in data communication with said computer.

6. The system of claim 5, wherein the update includes a request to access the database.

7. The system of claim 5, further comprising software executing on said computer for providing database access based on the rules in the ledger.

8. The system of claim 1, wherein the update and response are recorded on the ledger in a manner correlating the update and response.

9. The system of claim 1, further comprising software executing on said computer for transmitting a message based on the at least one of the update and response.

10. The system of claim 9, wherein the message is recorded on the ledger.

11. The system of claim 1, wherein the rules are project-based or user-based.

12. The system of claim 1, wherein the rules require a predetermined number of responses approving an update.

13. A decentralized resource planning system, comprising:
a computer;
a private ledger in data communication with said computer;
software executing on said computer for receiving rules and recording said rules on the private ledger;
software executing on said computer for receiving a user authorization and an update, and retrieving rules from the ledger based on the user authorization or the update;
software executing on said computer for transmitting the update based on the rules and receiving a response;
software executing on said computer for recording the update on the private ledger; and
software executing on said computer for transmitting at least one of the update and the response to a validator for recording the update on a public ledger.

14. The system of claim 143, wherein a token is transmitted to the validator for recording the update on the public ledger.

15. A decentralized resource planning system, comprising:
a computer;
a private ledger in data communication with said computer;
software executing on said computer for receiving rules and recording said rules on the private ledger;
software executing on said computer for transmitting the update based on the rules and receiving a response;
software executing on said computer for generating a transaction based on at least one of the update and the response;
software executing on said computer for recording the transaction on a private ledger; and
software executing on said computer for transmitting a token and the transaction to a validator for recording the update on a public ledger.

16. The system of claim 15, wherein the validator generates a hash based on the transaction and provides it to the computer.

17. The system of claim 15, further comprising a database in communication with said computer for storing at least one of the transaction and a hash.

18. The system of claim 15, further comprising software executing on said computer for receiving a search request and transmitting it to at least one of the private ledger and the public ledger; and software executing on said computer for receiving a search result and transmitting it based on the search request.

19. The system of claim 15, further comprising software executing on said computer for sending a request for the token to a wallet and receiving the token from said wallet.
